(19) United States
(12) Patent Application Publication
(10) Pub. No.: US 2007/0111619 A1
(43) Pub. Date: May 17, 2007

(54) Material and method of capturing oil

(76) Inventor: Damon Brink, Goleta, CA (US)

Correspondence Address: MARK RODGERS, 1590 SAN ROQUE ROAD, SANTA BARBARA, CA, 93105, US

(21) Appl. No.: 11/601,329

(22) Filed: Nov. 17, 2006

Related U.S. Application Data
(60) Provisional application No. 60/737,906, filed on Nov. 17, 2005.

(51) Int. Cl. B32B 5/02

(52) U.S. Cl. 442/59

(57) ABSTRACT

A material and method useful in absorbing oil is provided. Variations of the material and method are useful in removing an oils spill from the water the oil is contaminating. In the preferred embodiments, a very high density coating is applied to a substrate, preferably using a supercritical coating process. The coating may approximate a Self-Assembled-Monolayer in the best case.

### RELATED APPLICATIONS

This application claims priority to U.S. Provisional Application, Ser. No. 60/737,906, filed Nov. 17, 2005

### FIELD OF THE INVENTION

The Present Invention generally relates to materials and techniques used to absorb oils. And particularly to materials and techniques used to remove oils from environments.

### BACKGROUND OF THE INVENTION

Many prior art materials that are used to remove oil from an environment absorb both water and oil, making the process inefficient and the saturated material(s) used heavy with water. There are multiple prior art approaches to the problem, to include: a, mechanical containment and separation; b. dispersion and decomposition of oil; c. filtration of oil; and d. absorption of oil by substrate which will subsequently be removed.

In the prior art of oil absorption, specific prior art coatings have been used to attempt to create a hydrophobic surface which will therefore selectively adhere to a surface. Other prior art materials have been manufactured to be hydrophobic in nature such as polymer beads, where materials must then come into contact with the oil and be removed in some way. Other prior art approaches create a hydrophobic coating on the surface of oil-retaining particles, but these are particles not easily removed from the surface of the water—without water entrapment—by mechanical means. The prior art coated materials do not apparently absorb more than 1-2 times the weight of the material in oil. Typical prior art coating methodologies do not allow substrates with high porosity to be effectively coated without clogging the pores of the substrates, making the oil-absorbing particles a less-effective sorbant due to decreased effective surface area. The prior approaches that include making a polymer fiber or particle to absorb the oil from the water can be costly as they do not take advantage of cheap substrate material. These materials may also present a lower surface area per weight than some materials. There is therefore a long felt need to provide material and method to effectively and cost-efficiently separate and remove oil from certain environments, including water polluted by an oil spill.

### OBJECTS OF THE INVENTION

Certain preferred embodiments of the Method of the Present Invention have one or more of the following objects:
It is an object of the invention to provide a material and means for creating material that selectively absorbs oil without absorbing water.
It is an object of the invention to provide a means for treating many different types of substrates with a hydrophobic coating that will act as an oil-absorbing compound, allowing regionally available, inexpensive substrates to be used.
It is an object of the invention to provide a means for treating various blends of substrate material to provide an array of mechanical properties and oil absorption capabilities.
It is an object of the invention to provide a coated material that has a very high affinity for oil and will contain oil after absorption even in environments with high levels of agitation.
It is an object of the invention to provide a means for coating a highly porous material without blocking any of the pores. In this way, the resulting oil absorbing material will fully utilize the available surface area and maximize the absorption capability.
In a preferred embodiment of the present invention, it is an objective to provide a material that will absorb in 10× to 40× its weight in oil while absorbing less than 0.1× its weight in water.
In a preferred embodiment of the present invention, it is an objective to provide a material that forms a continuous mat which will not separate in environments with high agitation and are easily removed from the surface of the water.
In a preferred embodiment of the present invention, it is an objective to provide a material that can be used as a filter in storm drains to separate oil from runoff water.
In a preferred embodiment of the present invention, it is an objective to provide a material from which absorbed oil can be extracted and reclaimed.

### SUMMARY OF THE INVENTION

Towards these and other objects that will be made obvious in light of the present disclosure, a material and method is provided to absorb oil. A first preferred embodiment of the Method of the Present Invention absorbs oil from water. This method useful for cleaning oil spills, where the oil is on the surface of the water; for environmental protection where oil can be filtered from water in storm drains; and in pipes where oil contaminates need to be separated from water.

Certain alternate preferred embodiments of the present invention involve coating a substrate with a hydrophobic molecule. The method of deposition enables the uniform deposition of chemistry throughout a very porous material without changing the effective porosity. Very fine particles with mean diameters of 20 nm and below can be similarly treated. The treatment may include the application of supercritical carbon dioxide. A single monolayer can be formed on the surface of the substrate, thus not substantially changing the weight of the material and adding minimal hydrophobic material cost. Also, multiple type of substrates with different compositions and morphologies can be coated. This allows the porosity, density, and other characteristics of the resulting material to be easily tailored. Lastly, this coating can be made to covalently bond with the surface of the substrate which causes the absorbed oil to “lock” into place.

Certain still alternate preferred embodiments of the present invention allow coatings of multiple types of substrates. Very small particles, small fibers, large fibers, or combinations thereof can be treated. Oil absorption can thus be maximized or improved by creating the appropriate porosity profile and the mechanical characteristics of the material can be structured to facilitate easy removal. The molecules put down can be very hydrophobic, such that the absorbed oil is “locked” into place more effectively so that less oil can seep from the material. Also, the material does not absorb any water, so only oil is picked up from the surface. Straw, glass fiber, particles, nanoparticles, and combinations thereof can be similarly treated.

The ability to coat very small structures allows structures with specific gravities greater than 1 gm/cm³ to be buoyant, enabling diatomaceous earth and fine sand to be used as substrates without having the substrate sink. This also allows the material to absorb a much larger percentage of the materials mass in oil. Initial testing has showed a commercially available, oil-absorbing polymer mat absorbed ˜10 times its weight in oil from water. A specially treated fine fiber was able to absorb ˜40 times its weight in oil. Typical absorption weights for coated materials are on the order of ˜2 times the weight in oil. This material would also be appropriate for forced filtration of oil from water, or serve as an oleophilic filtration material for storm drains.

In addition, the manner in which the deposition is done (supercritical CO₂) facilitates very high rates of diffusion and allows many types of molecules to self-assemble on the surface of substrates. The formation of self-assembled monolayers (SAMs) creates a highly ordered surface structure with a high bond density. In other words, there are more molecules per surface area associated with SAMs than non-ordered surface coatings. This high bond density allows the coating to be more active—since there are more functional groups per area—and enables more effective absorption of oil. However, a perfect SAM coating is desirable, but is not necessary to achieve the objects of the invention. An important aspect of the invention is achieving higher density and better alignment of functional molecular structures. A SAM coating is particularly beneficial for many applications, but perfect uniform SAM coverage is not strictly necessary as long as density and alignment characteristics of the coating are adequate.

The application in certain yet alternate preferred embodiments of the Present Invention of supercritical CO₂ deposition allows small structured substrates to be coated, which in turn allows greater oil absorption per weight, coating of inexpensive substrates like sand and diatomaceous earth, and allows them to float on water due to surface tension arguments

The foregoing and other objects, features and advantages will be apparent from the following description of the preferred embodiment of the invention as illustrated in the accompanying drawings.

### BRIEF DESCRIPTION OF THE FIGURES

In describing the preferred embodiments, certain terminology will be utilized for the sake of clarity. Such terminology is intended to encompass the recited embodiment, as well as all technical equivalents, which operate in a similar manner for a similar purpose to achieve a similar result.

FIG. 1 is a generic processing flow for supercritical deposition of hydrophobic surface chemistries.

FIG. 2 is an illustration of a first preferred embodiment of the absorbent material treated in the process of FIG. 1 distributed in water.

### DETAILED DESCRIPTION OF PREFERRED EMBODIMENTS OF THE INVENTION

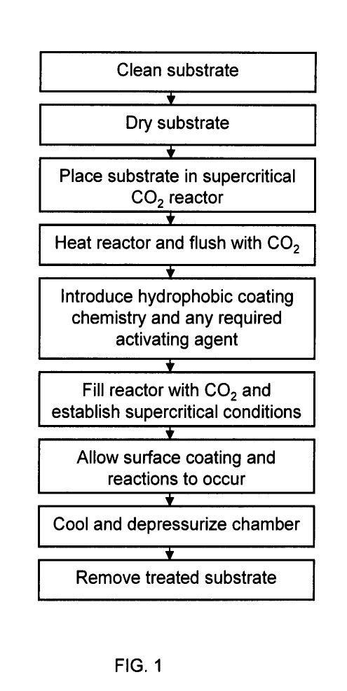

Referring now generally to the Figures, and particularly to FIG. 1, the Method of the Present Invention includes a process for applying the oil absorption (hydrophobic) coating 1 to the surface of substrates 4 of FIG. 1. Depending on the source and quality of the substrate 4, or material 4, the material 4 may have to be cleaned to remove dirt and oil from the surface. Solvents or surfactants may be used, but should be rinsed well so as not to leave residue on the substrate surface. The next step is to dry the substrate 4 thereby removing excess water from the surface and create a consistent and controlled surface condition. The material is then placed into the supercritical reactor, which in essence is a pressure vessel with controlled temperature and CO₂ pressure. With the substrate inside, the vessel is heated and flushed with CO₂ to purge the system and further clean the surface.

The next step is to introduce the surface chemistry and any activating agent into the chamber, followed by heating and pressurizing the chamber to achieve supercritical conditions. The constituents are given time to react and form the surface coating, and the chamber is then depressurized and cooled. The treated substrate is then removed from the chamber.

### First Preferred Embodiment

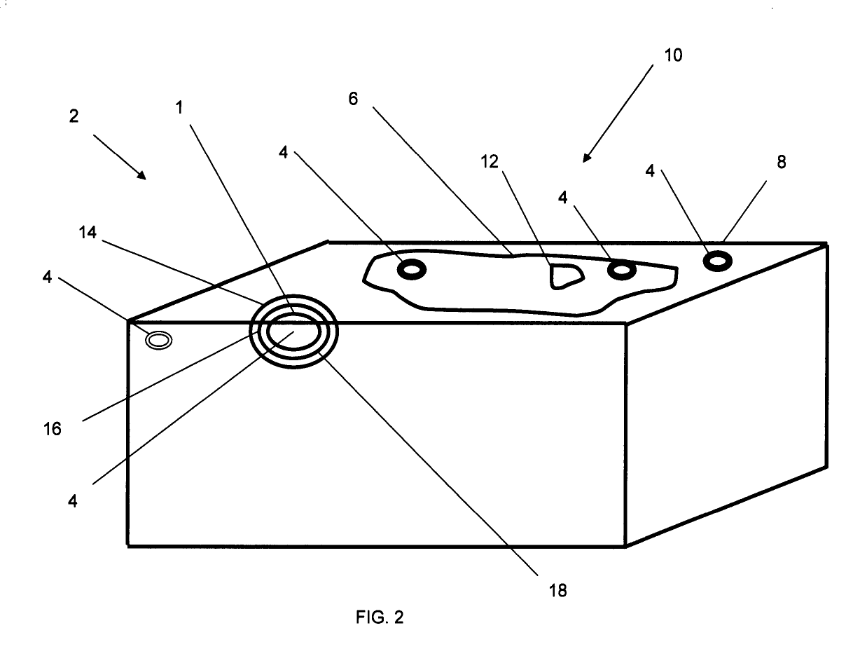

Referring now generally to the Figures, and particularly to FIG. 2, in a first preferred embodiment of the present invention 2, pristine glass microfibers available from Johns Manville as MicroStrand™ 100 are used as the substrate material 4. One pound of the microfiber material 4 is processed in the present example. The deposition process is scaleable, however, and much larger volumes of microfiber can be processed with a concomitant increase in surface chemistry and reaction chamber size.

The microfibers 4 are placed directly into the chamber and contained in a perforated stainless steel fixture. No washing is required as the packaging and handling of the fibers is sufficient to keep the substrate clean. The chamber is then sealed and heated to 120° C. to eliminate excess adsorbed moisture from the surface of the fibers. Once this temperature is reached, the chamber is flushed twice with CO₂ by pressurizing the chamber to 100 psi and subsequently venting to atmospheric pressure.

A small orifice in the top of the pressure vessel is then opened and 19 mL of octylthriethoxy silane (OTS) is metered into the chamber using a pipette. The orifice is then closed, and the chamber is pressurized to 1500 psi and heated to 150° C. During the ramp-up period, a magnetic stir drive is engaged to introduce a low level of mechanical agitation within the chamber to ensure dispersion of the surface chemistry. Once the target pressure and temperature are reached, the chamber conditions are held static for 30 minutes to allow the surface reactions to occur. During this time, the molecules of OTS are arranged on the surface, in some cases via a process of self-assembly. A condensation reaction between the OTS and substrate then creates a covalent bond that permanently attaches the two materials. The chamber is then cooled and depressurized, the magnetic drive disengaged, and the treated microfiber removed.

In this form, the microfiber material 4 is ready to apply to the surface of an oil slick 6. This may be done by casting the material 4 onto the surface of water 8 or by dragging the material 4 over the contaminated region 10. Alternatively, contaminated water 12 may be pumped through the microfiber material 4 which will separate and contain the oil 14 of the oil slick 6. The oil 14 can be extracted from the microfibers by applying pressure to the material 4. The treated material 4 may then be reused to collect more oil 14, and the extracted oil 14 can be recycled. Using this material 4 and methodology, a continuous extraction system can be fabricated wherein a continuous moving filter of microfiber material 4 is first subjected to a flowing fluid mixture of oil 14 and water 8, the oil 14 is absorbed by the fiber 4, the fiber 4 is then passed through rollers to remove the oil 14, and then returned to the flowing water 8 to capture additional oil 14.

### Second Preferred Embodiment

In a second preferred embodiment of the present invention, diatomaceous earth is used as the substrate material 4. One pound of the material 4 is processed in the present example. The deposition process is scaleable, however, and much larger volumes of diatomaceous earth can be processed with a concomitant increase in surface chemistry and reaction chamber size.

The substrate material 4 is washed with water to remove debris and placed into the chamber where it is contained in a perforated stainless steel fixture. The chamber is then sealed and heated to 120° C. to eliminate excess adsorbed moisture from the surface of the material. Once this temperature is reached, the chamber is flushed twice with CO₂ by pressurizing the chamber to 100 psi and subsequently venting to atmospheric pressure.

A small orifice in the top of the pressure vessel is then opened and 15 mL of octylthriethoxy silane (OTS) is metered into the chamber using a pipette. The orifice is then closed, and the chamber is pressurized to 1500 psi and heated to 150° C. During the ramp-up period, a magnetic stir drive is engaged to introduce a low level of mechanical agitation within the chamber to ensure dispersion of the surface chemistry. Once the target pressure and temperature are reached, the chamber conditions are held static for 30 minutes to allow the surface reactions to occur. During this time, the molecules of OTS are arranged on the surface, possibly via a process of self-assembly. A condensation reaction between the OTS and substrate then creates a covalent bond that permanently attaches the two materials. The chamber is then cooled and depressurized, the magnetic drive disengaged, and the treated material removed.

In this form, the diatomaceous earth is ready to apply to the surface of an oil slick 6. This may be done by casting the material 4 onto the surface of the water 8 or by constraining the material 4 in a net and dragging over the contaminated region. Alternatively, the contaminated water 8 may be pumped through the treated diatomaceous earth which will separate and contain the oil. The oil 14 can be extracted from material by heating the material beyond the degradation temperature of the OTS.

An oleophilic coating 16 possibly comprised of a self-assembled monolayer 18 may be added to the material 4 prior to introduction of the material 4 to the water 8. The method of forming the oleophilic 16 coating on the surface of the substrate 4, wherein the material 4, or substrate 4, may include porous materials, powders, and fibrous materials, and the coating 16 may be comprised of a self-assembled monolayer 18.

Those skilled in the art will appreciate that various adaptations and modifications of the just-described preferred embodiments can be configured without departing from the scope and spirit of the invention. Other suitable fabrication, manufacturing, assembly, and test techniques and methods known in the art can be applied in numerous specific modalities by one skilled in the art and in light of the description of the present invention described herein. For instance, many different types of surface chemistries can be used as an alternative to OTS in establishing the hydrophobic coating. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

I claim:

1. A substrate treated with an oleophilic coating wherein said coating is adapted to absorb petroleum based substances.

2. The treated substrate of claim 1 wherein the substrate absorbs at least 10× its weight in petroleum.

3. The treated substrate of claim 1 wherein the substrate absorbs at least 20× its weight in petroleum.

4. The treated substrate of claim 1 wherein the substrate absorbs at least 40× its weight in petroleum.

5. The treated substrate of claim 1 wherein the substrate absorbs less than 0.1× its weight in water.

6. The treated substrate of claim 1 adapted such that petroleum can be extracted from the substrate.

7. The treated substrate of claim 1 wherein the substrate is comprised of diatomaceous earth, glass fiber, sand, straw, particles, nanoparticles, and combinations thereof.

8. The treated substrate of claim 1 wherein the coating is applied in a manner which includes processing with supercritical carbon dioxide.

9. A substrate treated with an oleophilic coating which forms a continuous mat or gel.

10. The treated substrate of claim 8 wherein the substrate is at least partly comprised of fibers to impart mechanical strength to the continuous mat.
